(19) United States
(12) Patent Application Publication
(10) Pub. No.: US 2026/0319692 A1
(43) Pub. Date: Oct. 15, 2026

(54) MEMORY REPLACEMENT TECHNIQUES FOR MEMORY SUBSYSTEMS

(71) Applicant: Micron Technology, Inc., Boise, ID (US)

(72) Inventors: Marco Sforzin, Cernusco Sul Naviglio (MI) (IT); Su Wei Lim, Penang (MY); Emanuele Confalonieri, Segrate (IT)

(21) Appl. No.: 19/635,185

(22) Filed: Mar. 31, 2026

Related U.S. Application Data
(60) Provisional application No. 63/786,857, filed on Apr. 10, 2025.

(51) Int. Cl. G06F 3/06

(52) U.S. Cl. CPC G06F 3/0655; G06F 3/0604; G06F 3/0673

(57) ABSTRACT

Methods, systems, and devices for memory replacement techniques for memory subsystems are described. The memory system may include one or more extra capacity dies configured to store corrected data from failed memory dies. A quantity of the extra capacity dies may be based on an access granularity for the memory system and a type of data correction scheme supported by the memory system. A failed die may include a threshold quantity of errors. The memory system may identify one or more failed dies and may correct errors in the stored data using the data correction scheme supported by the memory system. The memory system may select at least one extra capacity die and may write the corrected data to the selected extra capacity die. The extra capacity die may thereby act as a replacement for at least a portion of the failed die.

### CROSS REFERENCE

The present Application for Patent claims priority to U.S. Patent Application No. 63/786,857 by Sforzin et al., entitled “MEMORY REPLACEMENT TECHNIQUES FOR MEMORY SUBSYSTEMSE,” filed Apr. 10, 2025, which is assigned to the assignee hereof, and which is expressly incorporated by reference in its entirety herein.

### TECHNICAL FIELD

The following relates to one or more systems for memory, including memory replacement techniques for memory subsystems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports memory replacement techniques for memory subsystems in accordance with examples as disclosed herein.

FIGS. 2A and 2B show examples of die replacement schemes that support memory replacement techniques for memory subsystems in accordance with examples as disclosed herein.

FIGS. 3A and 3B show examples of die replacement schemes that support memory replacement techniques for memory subsystems in accordance with examples as disclosed herein.

FIG. 4 shows a block diagram of a memory system that supports memory replacement techniques for memory subsystems in accordance with examples as disclosed herein.

FIGS. 5 and 6 show flowcharts illustrating a method or methods that support memory replacement techniques for memory subsystems in accordance with examples as disclosed herein.

### DETAILED DESCRIPTION

Some memory systems may include multiple memory dies. In some examples, a memory die may fail if a threshold quantity of errors occur in data stored in the memory die. A memory system may use an error control scheme for detection of a failed memory die and correction of the errors in the data stored to the failed memory die. The error control scheme may be a single die data correction (SDDC) scheme or a double die data correction (DDDC) scheme, among other examples. In some examples, the memory system may use the error control scheme and one or more codewords associated with the failed memory die to correct the data. For example, a codeword may include data from the memory die and multiple other memory dies along with parity information stored to one or more parity dies within a data stripe of the memory system. The memory system may fix the failed memory die by writing the corrected data back to the memory die. However, a failed memory die may be susceptible to additional subsequent errors, which may decrease reliability of the data and increase a possibility for the memory system to experience uncorrectable errors.

Techniques, systems, and devices described herein provide for a memory system (e.g., a double data rate 4 synchronous dynamic random-access memory (DDR4 SDRAM) system) to include one or more extra capacity dies configured to store corrected data from failed memory dies, thereby increasing a reliability and error correction capability of the memory system. The one or more extra capacity dies may be configured upon initialization of the memory system along with one or more data dies configured to store data for operations of the memory system and one or more parity dies configured to store parity information associated with the data. A data stripe within the memory system may include a set of data dies, one or more extra capacity dies, and one or more parity dies, where each data stripe may include one or more codewords that can be used to correct errors in data within the data stripe. A data stripe may correspond to an access granularity at which the memory system is accessed, in some examples.

If the memory system identifies one or more failed memory dies (e.g., one die for an SDDC scheme or two dies for a DDDC scheme), the memory system may correct the data using one or more corresponding codewords and a data correction scheme supported by the memory system. The memory system may select at least one extra capacity die, or one or more banks of the extra capacity die, and may store the corrected data to the selected extra capacity die. After writing the corrected data to the extra capacity die, the memory system may replace the errored data in the failed memory die with null data (e.g., all zeros, random data, dummy data, or the like) when obtaining the codeword for subsequent error corrections, which may be referred to as padding the failed die. In some examples, the memory system may perform such die correction and replacement techniques according to a 128 byte (B) or a 256B access granularity, or some other granularity. A quantity of extra capacity dies included in the memory system and available for die replacement may be based on (e.g., correlated to) an access granularity of the memory system and a corresponding error correction scheme supported by the memory system (e.g., SDDC or DDDC). The memory system may use one or two codewords to facilitate the correction of data before moving the data to one or more replacement dies, where a quantity of codewords may be based on the access granularity and the error correction scheme. The memory system may replace a quantity of failed memory dies that is less than or equal to a quantity of extra capacity dies (e.g., if the memory system includes six extra capacity dies, it may replace up to six failed memory dies). After writing corrected data to all extra capacity dies in the memory system, the memory system may continue to correct data in failed dies in accordance with the data correction scheme, but may not replace those dies.

In addition to applicability in memory systems as described herein, techniques for memory replacement may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for memory replacement may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by increasing data correction scheme reliability, which may extend the life of electronic devices and thereby reducing electronic waste, among other benefits.

Features of the disclosure are illustrated and described in the context of systems and architectures. Features of the disclosure are further illustrated and described in the context of die replacement schemes and flowcharts.

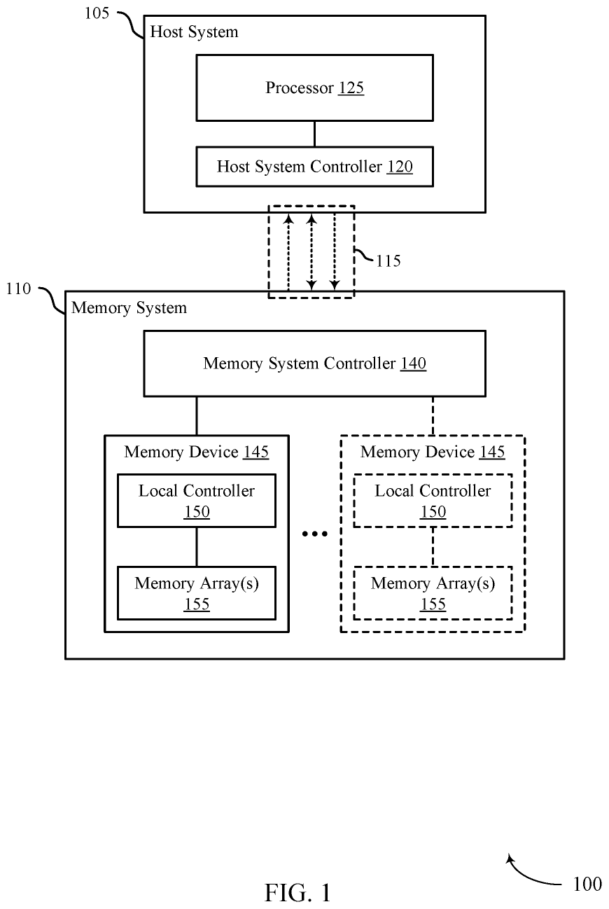

FIG. 1 shows an example of a system 100 that supports memory replacement techniques for memory subsystems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not- or (NOR) memory cells, and not- and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Some memory systems 110 may include multiple memory devices 145 (e.g., memory dies), and each memory die may include multiple memory banks. In some examples, a respective memory die or bank may fail when a threshold quantity of errors occur in data stored in the memory die or bank. The memory system 110 may use an error control scheme for detection of a failed memory die or bank and to correct the data. For example, some memory systems 110 may detect and correct data in accordance with a SDDC scheme or a DDDC scheme, among other examples. In some examples, the memory system 110 may use parity information and one or more codewords associated with the failed memory die or bank to correct the data. However, while correcting the data may enable the host system 105 to access the data, failed memory dies or banks may be susceptible to further errors, and a capability of the memory system 110 to correct errors may be reduced.

As described herein, to improve reliability and longevity, the memory system 110 (e.g., a DDR4 SDRAM system) may include one or more extra capacity dies configured to store corrected data from failed memory dies or banks in accordance with the techniques described herein, thereby increasing the capability of the memory system 110 to correct errors. For example, the memory system 110 may identify one or more failed memory dies or banks and select at least one extra capacity die, or one or more banks of the extra capacity die, to store the corrected data from the one or more failed memory dies or banks. Based on writing the corrected data to the extra capacity die, the memory system 110 may write null data in the failed memory die or bank. In some examples, the memory system 110 may perform such die correction and replacement techniques according to a 128B or 256B access granularity, or some other granularity. A quantity of extra capacity dies included in the memory system 110 and available for die replacement may be based on (e.g., correlated to) an access granularity of the memory system 110 and a corresponding error correction scheme supported by the memory system 110 (e.g., SDDC or DDDC). The memory system 110 may use one or two codewords to facilitate the correction of data before moving the data to one or more replacement dies, where a quantity of codewords may be based on the access granularity and the error correction scheme. The memory system 110 may replace failed memory dies or banks up to the quantity of extra capacity dies (e.g., if the memory system 110 includes six extra capacity dies, the memory system 110 may replace six failed memory dies). After writing corrected data to all extra capacity dies in the memory system 110, the memory system 110 may continue to correct data in failed dies or banks in accordance with the data correction scheme.

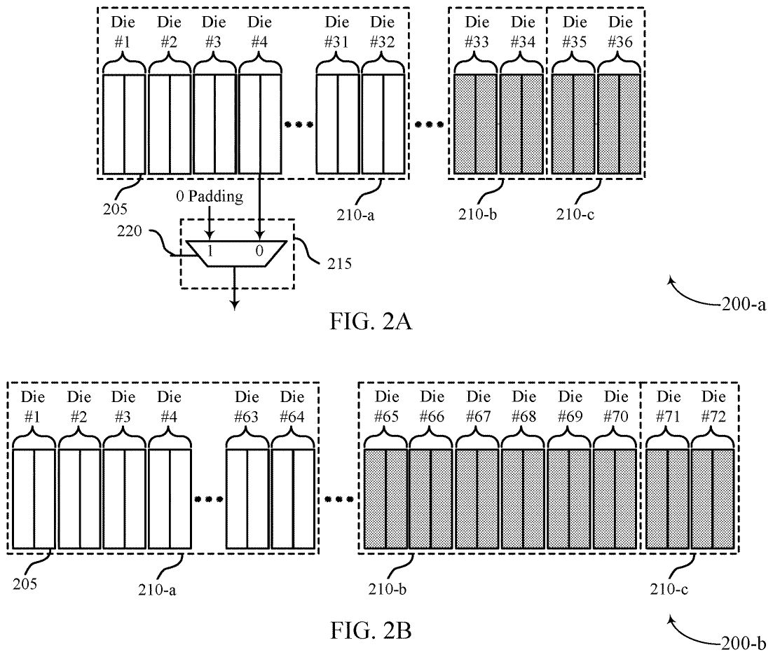

FIGS. 2A and 2B show examples of die replacement schemes 200 that support memory replacement techniques for memory subsystems in accordance with examples as disclosed herein. The die replacement schemes 200 may implement or be implemented by aspects of the system 100 as described with reference to FIG. 1. For example, the die replacement scheme 200-a and the die replacement scheme 200-b describe techniques for moving data corrected according to an SDDC scheme from a failed die to an extra capacity die 205 within a memory system including multiple dies, which may represent examples of the memory devices 145 described with reference to FIG. 1.

Further, although non-limiting examples of the die replacement schemes 200 herein are generally described in terms of applicability to memory systems, memory sub-systems, memory devices, or a combination thereof, examples of the die replacement schemes 200 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

In this example, the memory system may include one or more data dies 210-a, one or more parity dies 210-c, and one or more extra capacity dies 210-b. The memory system may configure the allocation of the data dies 205-a, the extra capacity dies 210-b, and the parity dies 210-c after initialization of the memory system, based on an indication received from a host system, or both. The data dies 210-a may be configured to store data within the memory system. For example, the data dies 210-a may store data for one or more host applications, metadata, or the like. The data dies 210-a may be accessed during access operations to the memory system. The parity dies 210-c may be configured to store parity information for an error correction scheme supported by the memory system. For example, the parity dies 210-c may store parity bits associated with the data stored across the data dies 210-a. The parity bits may be used to perform SDDC or some other error correction scheme supported by the memory system.

The extra capacity dies 210-b may be configured to store random data, extra data (e.g., data associated with other operations of the memory system), or both during initial operations of the memory system and may be configured as available for storage of corrected data moved from one or more of the data dies 210-a in response to detection of an error in the one or more data dies 210-a. For example, the techniques described herein may provide for a progressive or iterative replacement strategy. Each time a data die 210-a experiences a failure (e.g., at least a threshold quantity of errors), a spare resource from one of the extra capacity dies 210-b may be used to replace the failed data die 210-a.

As described herein, by including the extra capacity dies 210-b, the memory system may support improved reliability and performance as compared with systems that do not include extra capacity dies 210-b. For example, if a system does not include any extra capacity dies 210-b, and one of the data dies 210-a experiences an error or other failure, the memory system may correct the data die 210-a using a supported data correction scheme. However, the memory system may be capable of correcting up to one die (e.g., SDDC) or two dies (e.g., DDDC) at a time. As such, the likelihood of the data dies 210-a continuing to experience the same failures and two or more data dies 210-a failing at the same time may be relatively high. Thus, by replacing the data dies 210-a after any failure is detected and using the extra capacity dies 210-b, the memory system may improve reliability of data storage.

FIG. 2A illustrates a die replacement scheme 200-a that supports memory replacement techniques for memory subsystems in accordance with examples as disclosed herein. The die replacement scheme 200-a may implement or be implemented by aspects of the system 100 as described with reference to FIG. 1. For example, the die replacement scheme 200-a illustrates techniques for moving data corrected according to a first granularity (e.g., 128B) and an SDDC scheme from a failed data die 210-a to an extra capacity die 210-b within a memory system including multiple dies, which may represent examples of the memory devices 145 described with reference to FIG. 1.

In the examples of the die replacement scheme 200-a, each of the dies may include four access bits (e.g., DQ[0:3]). For example, each die may include two symbols 205 (e.g., two 16-bit symbols), where each symbol 205 is associated with two access bits of the four DQ access bits (e.g., each symbol is over two DQ bits and includes a burst length of eight bits, for a total of 16 bits). Thus, each die may store up to 32 bits. In the example illustrated in FIG. 2A, the memory system may include 32 data dies 210-a, two extra capacity dies 210-b, and two parity dies 210-c. In this example, the memory system may support a 128B access granularity (e.g., 32 data dies 210-a multiplied by 32 bits per die=128B). The 128B access granularity is illustrated for exemplary purposes. It is to be understood that the described techniques may be applied to a 256B access granularity, as illustrated in FIG. 2B, or any other access granularity, including larger or smaller access granularities not illustrated herein.

The two parity dies 210-c may support a first data correction capability. For example, the two parity dies 210-c may support an SDDC functionality, in which up to one data die of the data dies 210-a may be corrected at a given time (e.g., a single die per error correction operation) using a single codeword. The codeword may include both symbols 205 in each data die 210-a. A codeword for performing SDDC may have a length of 72B and may include a payload with a length of 68B (e.g., 4B for parity and/or extra capacity). The codeword may include or otherwise be associated with each of the data dies 210-a, the extra capacity dies 210-b, and the parity dies 210-c. In some examples, the parity information for a given stripe may be combined at an end of the stripe. For example, instead of including parity information in dies #17 and #18, as well as in dies #35 and #36, the techniques described herein may include data in the dies #17 and #18 (e.g., data dies 210-a) and may include parity information in the combined parity dies 210-c (e.g., dies #35 and #36), which may save room within the stripe for the extra capacity dies 210-b. In this example, a total quantity of parity dies 210-c and extra capacity dies 210-b may sum to four (e.g., because the previous four dies for parity may be combined to two dies in a given stripe with the 128B access granularity). For example, if there are three parity dies 210-c, there may be one extra capacity die 210-b, and the like. The quantity of parity dies 210-c that are included may be based on (e.g., configured to support) an associated error correction scheme, such as two parity dies 210-c for SDDC.

The data dies 210-a, the extra capacity dies 210-b, and the parity dies 210-c illustrated in FIG. 2A may represent an example of a data stripe for error correction (e.g., an SDDC stripe). In some examples, each data stripe may include or otherwise be associated with one codeword. If each die is divided into two 16-bit symbols, then a single codeword may include all symbols (e.g., symbols 0 and 1 in each of the dies #0 through #36) of the dies.

In the die replacement scheme 200-a, the memory system may support SDDC. As such, the memory system may be capable of correcting errors in a single data die 210-a using a codeword that includes data from each of the data dies 210-a, extra data from each of the extra capacity dies 210-b, and parity information from the parity dies 210-c. For example, the two parity dies 210-c may support SDDC functionality using a single codeword of a first size. In some examples, the error correction engine may support a 16-bit data correction scheme, such as a 16 bit 1xReed Solomon (RS) 16 b-1xRS2(72,68) scheme, or some other type of correction scheme. The 16 bit 1xRS2(72,68) scheme may enable the memory system to correct up to two symbols 205 within a die 210 using a single codeword, where the codeword may be 72 bits long and the payload of each codeword may be 68 bits long. In some examples, the length of the codeword may be based on a single die correction (SDC) threshold (e.g., longer codeword lengths may enable the memory system to correct more errors).

In the example of the die replacement scheme 200-a, the memory system may detect a failure associated with the die #4, which may be one of the data dies 210-a. For example, an error correction engine (e.g., an error correction code (ECC) core) within the memory system may detect that the data stored in one or more symbols 205 of the die #4 includes at least one error. The memory system may not detect errors in other data dies 210-a. A failed die as described herein may represent a die that includes at least one error, or some other threshold quantity of errors.

In some examples, a failed die may include errors throughout the die. Additionally, or alternatively, a failed die may include one or more failed banks of data and one or more other banks of data that included valid (e.g., correct) data without errors. A bank may represent a portion of a symbol 205, or some other granularity of data within each of the dies. In some examples, each symbol 205 may represent a bank-group including eight banks, 16 banks, or some other quantity.

After detecting the error in the die #4, the memory system (e.g., the ECC engine) may perform a data correction operation in accordance with a supported data correction scheme (e.g., SDDC) to correct the data in the die #4. For example, instead of writing the corrected data back to the die #4, the memory system may write the corrected data to one of the extra capacity dies 210-b. For example, the die #4 may be relatively more likely than other dies to experience failure again or otherwise experience continued errors over time. Thus, to improve reliability of the memory system (e.g., to reduce a quantity of subsequent error correction operations for the same die), the memory system may replace the die #4 with one of the extra capacity dies 210-b, such as the die #34.

Replacement of the die #4 may refer to moving the data from the die #4 to the replacement die #34. Subsequent accesses to the data may thereby be sourced from the die #34 instead of the die #4. In some examples, the memory system may replace all of the die #4 (e.g., a full die replacement). Additionally, or alternatively, the memory system may replace a portion of the die #4. For example, the memory system may perform die replacement at a bank level, or some other granularity within a die (e.g., at a block level). If the one or more detected errors are included in a quantity of one or more banks of the die #4, but not in all of the banks of the die #4, the memory system may, for example, correct the data in the identified banks and write the corrected data to a corresponding quantity of banks in the replacement die #34, but may not write to all banks in the replacement die #34, which may induce a smaller extra capacity reduction in each replacement (e.g., 1/32 smaller than a full die replacement).

In some examples, the memory system may select the replacement die #34 based on one or more parameters or criteria (e.g., a location of the replacement die #34, an availability of the replacement die #34 to store data, among other examples). For example, the memory system may select the replacement die #34 based on a location of the replacement die #34 from among the extra capacity dies 210-b (e.g., the memory system may select the last available replacement die from among the extra capacity dies 210-b). In another example, the memory system may select the replacement die #34 based on the replacement die #34 being available to store the corrected data. In some cases, the memory system may select the replacement die #34 while the replacement die #34 stores other data (e.g., data from a previous replacement scheme). In such cases, the memory system may move the data to another die (e.g., another replacement die or to a data die) before writing the corrected data to the replacement die #34.

The memory system may route, via a multiplexer 215, data from die #4 or null data towards an ECC engine based on whether the memory system wrote the corrected data to the replacement die #34 (e.g., or at least a portion of the replacement die #34). The ECC engine may implement data correction decoding (e.g., SDDC decoding) via one or more RS decoders. If the corrected data was written to the replacement die #34, a replacement flag 220 may be set to a first value (e.g., ‘1’), and the memory system may input null data into the ECC engine (e.g., to one or more RS decoders) to replace the previous data including the errors. That is, the multiplexer 215 may pad the data in die #4 with the null data (e.g., all “0” bits, or some other dummy data or random data), which may be referred to as writing the null data to replace the data previously stored to the die #4. For example, if the corrected data was not written to the replacement die #34, the replacement flag 220 may be set to a second value (e.g., ‘0’), and the memory system may input the data from die #4 (e.g., corrected data) to the ECC engine for codeword generation. In some examples, the memory system may route the data or null data via the multiplexer 215 based on performing a read operation (e.g., a read operation corresponding to the data from die #4 or the corrected data from replacement die #34) as part of a codeword generation. The codeword used by the memory system for correction may thereby include the null data instead of the previous data stored to the failed die based on the failed die being replaced.

In some examples, the die #4 may be associated with a single codewords as further described herein. For example, the codeword may include all the symbols 205 of the die #4. The codeword may further include data stored in data dies 210-a, data stored in the extra capacity dies 210-b, and parity information stored in the parity dies 210-c. Before correcting and replacing the data in die #4 with the null data, the codeword may have a first length (e.g., 72 symbols long). After correcting and replacing the data in die #4 with the null data, the codeword may have a second length shorter than the first length based on writing the null data in the die #4. For example, the codeword may include the data stored in a subset of the data dies 210-a and in the replacement die #34, the parity information, and the null data padded to (e.g., written over) the previous data stored in the die #4.

The memory system may store information (e.g., metadata information) associated with the die replacement scheme 200-a. For example, the memory system may store information that indicates which of the data dies 210-a are replaced with one of the extra capacity dies 210-b, which of the extra capacity dies 210-b store data from the data dies 210-a, or both. In some examples, the information may indicate one or more banks within the die #4 that include the null data (e.g., that include replaced data to be padded with the null data during an access operation). Additionally, or alternatively, the information may further indicate one or more banks within the replacement die #34 that are used to store the corrected data.

The memory system may continue to iteratively replace failed data dies from among the data dies 210-a or portions of failed data dies from among the data dies 210-a until all of the extra capacity dies 210-b are used. For example, the memory system may subsequently correct data in the die #31, write the corrected data to the die #33, and pad the die #31 with null data, and so on, in that order or any other order in which errors in the data dies 210-a are detected. If the memory system detects more than one failed data die 210-a at a time, and the memory system supports SDDC, the memory system may not be capable of correcting the data in both of the failed data dies from among the data dies 210-a, which may cause a failure. As such, the memory system may support the die replacement scheme described herein for a single data die 210-a at a time.

Once the last extra capacity die 210-b is used, the memory system may continue to support error correction using the codeword including the null data in any of the previously failed and replaced data dies 210-a, as well as the corrected data in the extra capacity dies 210-b. However, instead of writing the corrected data to an extra capacity die 210-b, the memory system may correct the data and write the corrected data back to the data die 210-a. For example, the memory system may detect a threshold quantity of errors in a data die, which may indicate a failure at the die-level or a bank-level. The memory system may correct the data using the SDDC scheme. The memory system may write the corrected data back to the die to replace the previous data that included the errors. The memory system may thereby continue to operate until a quantity of detected errors exceeds a correction capability of the memory system.

Although the replacements are illustrated as a one-to-one mapping, it is to be understood that, in some examples, the memory system may use a single extra capacity die 210-b to replace data in respective portions of two or more data dies 210-a. For example, if a bank in the die #4 fails, the memory system may correct the data in the bank and write the corrected data to a bank in an extra capacity die 210-b (e.g., the die #34, for example). If the memory system subsequently detects a failed bank in another die, such as the die #31, the memory system may correct the data in the bank and write the corrected data to another bank in the same extra capacity die #34. Thus, a single extra capacity die may store corrected data for more than two failed data dies from among the data dies 210-a, in some examples.

The memory system may store replacement information that indicates locations of each of the failed data dies from among the data dies 210-a and failed banks within the data dies 210-a, as well as locations of each of the extra capacity dies 210-b and banks within the extra capacity dies 210-b that are used to store replacement data (e.g., corrected data), as described in further detail elsewhere herein, including with reference to FIG. 2A.

The memory system may thereby perform iterative die replacements when one or more data dies 210-a fail, up to an available extra capacity. The available extra capacity may be reduced with each replacement. For example, the extra capacity may start at around 20 percent of a total capacity of the data stripe, or some other percentage, and may be reduced with each replacement until the available extra capacity is zero. Each full-die replacements may reduce the available extra capacity more than bank-level replacements.

FIG. 2B illustrates a die replacement scheme 200-b that supports memory replacement techniques for memory subsystems in accordance with examples as disclosed herein. The die replacement scheme 200-b may implement or be implemented by aspects of the system 100 as described with reference to FIG. 1. For example, the die replacement scheme 200-b describes techniques for moving data corrected according to an SDDC scheme from a failed data die 210-a to an extra capacity die 210-b within a memory system including multiple dies, which may represent examples of the memory devices 145 described with reference to FIG. 1.

The memory system may perform one or more error correction and die replacement operations according to the techniques described herein with reference to FIG. 2A. For example, the die replacement scheme 200-b illustrates a scheme for performing die replacement using SDDC error correction and one or more replacement or extra capacity dies 210-b, but according to a different access granularity than the access granularity illustrated in FIG. 2A. For example, the die replacement scheme 200-b may be associated with an access granularity of 256B. The memory system may perform one or more die replacement techniques on the die replacement scheme 200-b as described herein with reference to FIG. 2A, but in accordance with the 256B access granularity. Although not illustrated in FIG. 2B, it is to be understood that the memory system may include a multiplexer, such as the multiplexer 215 in FIG. 2A, and the memory system may pad data from failing dies with zeros when writing to an ECC engine via the multiplexer if the failed dies have been replaced (e.g., the data has been moved to an extra capacity die 210-b).

In the example of the die replacement scheme 200-b, each of the dies may include four access bits (e.g., DQ[0:3]). For example, each die may include two symbols 205 (e.g., two 16-bit symbols), where each symbol 205 is associated with two access bits of the four access bits (e.g., each symbol is over two DQ bits and includes a burst length of eight bits, for a total of 16 bits). Thus, each die may store up to 32 bits. In the example illustrated in FIG. 2B, the memory system may include 64 data dies 210-a, six extra capacity dies 210-b, and two parity dies 210-c. In this example, the memory system may support a 256B access granularity (e.g., 64 data dies 210-a multiplied by 32 bits per die=256B). The 256B access granularity is illustrated for exemplary purposes. It is to be understood that the described techniques may be applied to a 128B access granularity, as illustrated in FIG. 2A, or any other access granularity, including larger or smaller access granularities not illustrated herein.

As described herein, the parity information for a given stripe (e.g., 256B access stripe) may be combined at an end of the stripe. For example, instead of including parity information in the last two dies of each group of 18 dies (e.g., in dies #17, #18, #35, #36, #53, #54, #71, and #72), the parity information may be combined and included in the last two dies of the entire stripe, such as the parity dies 210-c in FIG. 2B (e.g., dies #71 and #72). As such, the other dies previously used for storing parity information may become available and may be repurposed as extra capacity dies 210-b. Thus, the memory system may include six extra capacity dies 210-b in this example, two parity dies 210-c, and 64 data dies 210-a.

In the die replacement scheme 200-b, the memory system may support a first data correction capability, such as SDDC. For example, the two parity dies 210-c may support SDDC functionality using a single codeword of a first size, as described herein with reference to FIG. 2A. In accordance with the larger access granularity of 256B in this example, the error correction engine may support a 16-bit data correction scheme with a relatively larger codeword than a codeword used for SDDC at a 128B access granularity. For example, the error correction engine may support a 16 bit 1xRS 16 b-1xRS2(144,140) scheme, or some other type of correction scheme. The 16 bit 1xRS2(144,140) scheme may enable the memory system to correct up to two symbols 205 within a die 210 using a single codeword, where the codeword may be 144B long and the payload of each codeword may be 140B long. The single codeword may include both symbols 205 in each data die 210-a, as further described herein with reference to FIG. 2A.

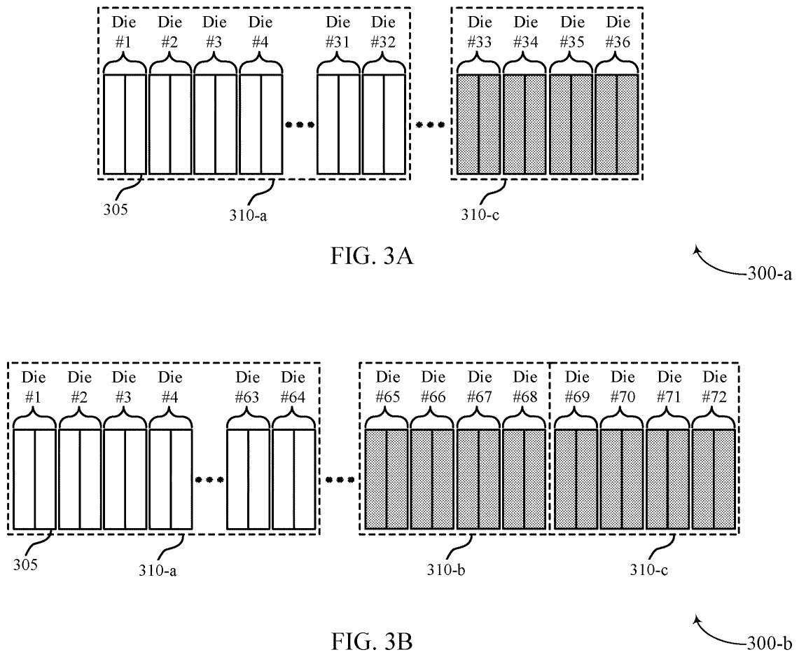

FIGS. 3A and 3B shows an example of die replacement schemes 300 that support memory replacement techniques for memory subsystems in accordance with examples as disclosed herein. The die replacement scheme 300 may implement or be implemented by aspects of the system 100 as described with reference to FIG. 1. For example, the die replacement scheme 300-a and the die replacement scheme 300-b describe techniques for moving data corrected according to a DDDC scheme from a failed die to an extra capacity die 310-b within a memory system including multiple dies, which may represent examples of the memory devices 145 described with reference to FIG. 1.

In this example, the memory system may include one or more data dies 310-a, one or more parity dies 310-c, and one or more extra capacity dies 310-b, which may represent examples of corresponding dies as described with reference to FIGS. 2A and 2B. The memory system may configure the allocation of the data dies 305-a, the extra capacity dies 310-b, and the parity dies 310-c after initialization of the memory system, based on an indication received from a host system, or both. The data dies 310-a may be configured to store data within the memory system. For example, the data dies 310-a may store data for one or more host applications, metadata, or the like. The data dies 310-a may be accessed during access operations to the memory system. The parity dies 310-c may be configured to store parity information for an error correction scheme supported by the memory system. For example, the parity dies 310-c may store parity bits associated with the data stored across the data dies 310-a. The parity bits may be used to perform DDDC or some other error correction scheme supported by the memory system.

The extra capacity dies 310-b may be configured to store random data, extra data (e.g., data associated with other operations of the memory system), or both during initial operations of the memory system and may be configured as available for storage of corrected data moved from one or more of the data dies 310-a in response to detection of an error in the one or more data dies 310-a. For example, the techniques described herein may provide for a progressive or iterative replacement strategy. Each time a data die 310-a experiences a failure (e.g., at least a threshold quantity of errors), a spare resource from one of the extra capacity dies 310-b may be used to replace the failed data die 310-a.

As described herein, by including the extra capacity dies 310-b, the memory system may support improved reliability and performance as compared with systems that do not include extra capacity dies 310-b. For example, if a system does not include any extra capacity dies 310-b, and one of the data dies 310-1 experiences an error or other failure, the memory system may correct the data die 310-a using a supported data correction scheme. However, the memory system may be capable of correcting up to one die (e.g., SDDC) or two dies (e.g., DDDC) at a time. As such, the likelihood of the data dies 310-a continuing to experience the same failures and two or more data dies 310-a failing at the same time may be relatively high. Thus, by replacing the data dies 310-a after any failure is detected and using the extra capacity dies 310-b, the memory system may improve reliability of data storage.

FIG. 3A illustrates a die replacement scheme 300-a that supports memory replacement techniques for memory subsystems in accordance with examples as disclosed herein. The die replacement scheme 300-a may implement or be implemented by aspects of the system 100 as described with reference to FIG. 1. The die replacement scheme 300-a illustrates an example of a memory layout in which extra capacity dies 310-b may not be included. For example, when a memory system supports a 128B access granularity and a DDDC correction scheme, the memory system may not support extra capacity (e.g., due to the required amount of parity information for DDDC).

In the example of FIG. 3A, each of the dies of the die replacement scheme 300-a may include four access bits (e.g., DQ[0:3]). For example, each die may include two symbols 305, where each symbol 305 is associated with two access bits of the four DQ access bits (e.g., each symbol is over two DQ bits and includes a burst length of eight bits, for a total of 16 bits. Thus, each die may store up to 32 bits. In the example illustrated in FIG. 3A, the memory system may include 32 data dies 310-a, four parity dies 310-c, and no extra capacity dies 310-b. In this example, the memory system may support a 128B access granularity (e.g., 32 data dies 310-a multiplied by 32 bits per die=128B). The 128B access granularity is illustrated for exemplary purposes. It is to be understood that the described techniques may be applied to a 256B access granularity, as illustrated in FIG. 3B, or any other access granularity, including larger or smaller access granularities not illustrated herein.

The four parity dies 310-c may support a second data correction capability. For example, the four parity dies 310-c may support a DDDC functionality, in which up to two data dies of the data dies 310-a may be corrected at a given time (e.g., two dies per error correction operation). As such, the memory system may not have extra parity dies 310-c that can be combined and repurposed as extra capacity dies. A codeword for performing DDDC may have a length of 36 bits and may include a payload with a length of 32 bits. In some examples, the die replacement scheme 300-a may be associated with two codewords. For example, the data dies 310-a and the parity dies 310-c illustrated in FIG. 3A may represent an example of a data stripe for error correction (e.g., a DDDC stripe). In some examples, each data stripe may include two codewords. If each die is divided into two 16-bit symbols, then a first codeword may include all even symbols (e.g., each second symbol in each of the dies #0 through #32), and a second codeword may include all odd symbols (e.g., each first symbol in each of the dies #0 through #32). Additionally, or alternatively, a first codeword may include each odd symbol in each die, and the second codeword may include each even symbol in each die, or some other combination of symbols across dies, such that the data stripe includes two codewords. Dice in each codeword may be from different physical channels or different physical ranks, in some examples.

The memory system may be capable of correcting errors in two or more data dies 310-a using the codewords that each include data from the data dies 310-a and parity information from the parity dies 310-c. For example, the four parity dies 310-c may support DDDC functionality using two codewords each associated with a first size. In some examples, the error correction engine may support a 16-bit data correction scheme, such as a 16 bit 2xRS2(36,32) scheme, or some other type of correction scheme, including an 8-bit scheme, or other scheme. The 16 bit 2xRS2(36,32) scheme may enable the memory system to correct up to two symbols using the two codewords, where each codeword may be 36 bits long and the payload of each codeword may be 32 bits long. In some examples, the length of the codeword may be based on a double die correction (DDC) threshold.

In this example, the memory system may correct errors within two data dies 310-a at a time. However, the memory system may write the corrected data back to the same data dies 310-a. As such, if a data die 310-a continues to fail or otherwise becomes unrecoverable, the memory system may lose the data in that die.

FIG. 3B illustrates a die replacement scheme 300-b that supports memory replacement techniques for memory subsystems in accordance with examples as disclosed herein. The die replacement scheme 300-b may implement or be implemented by aspects of the system 100 as described with reference to FIG. 1. For example, the die replacement scheme 300-b describes techniques for moving data corrected according to a DDDC scheme from a failed data die 310-a to an extra capacity die 310-b within a memory system including multiple dies, which may represent examples of the memory devices 145 described with reference to FIG. 1.

The memory system may perform one or more error correction and die replacement operations according to the techniques described herein with reference to FIG. 2A-3A. For example, the die replacement scheme 300-b illustrates a scheme for performing die replacement using DDDC error correction and one or more replacement or extra capacity dies 310-b, but according to a different access granularity than the access granularity illustrated in FIG. 3A. For example, the die replacement scheme 300-b may be associated with an access granularity of 256B. The memory system may perform one or more die replacement techniques on the die replacement scheme 300-b as described herein with reference to FIGS. 2A and 2B, but in accordance with the 256B access granularity and a DDDC scheme. Although not illustrated in FIG. 3B, it is to be understood that the memory system may include a multiplexer (e.g., not illustrated), and the memory system may pad data from failing dies with zeros when writing to an ECC engine via the multiplexer if the failed dies have been replaced (e.g., the data has been corrected and moved to an extra capacity die 310-b).

In the example of the die replacement scheme 300-b, each of the dies may include four access bits (e.g., DQ[0:3]). For example, each die may include two symbols 305, where each symbol 305 is associated with two access bits of the four DQ access bits (e.g., each symbol is over two DQ bits and includes a burst length of eight bits, for a total of 16 bits). Thus, each die may store up to 32 bits. In the example illustrated in FIG. 3B, the memory system may include 64 data dies 310-a, four extra capacity dies 310-b, and four parity dies 310-c. In this example, the memory system may support a 256B access granularity (e.g., 64 data dies 310-a multiplied by 32 bits per die=256B). The 256B access granularity is illustrated for exemplary purposes. It is to be understood that the described techniques may be applied to a 128B access granularity, as illustrated in FIG. 3A, or any other access granularity, including larger or smaller access granularities not illustrated herein.

As described herein, the parity information for a given stripe (e.g., 256B access stripe) may be combined at an end of the stripe. For example, instead of including parity information in the last two dies of each group of 18 dies (e.g., in dies #17, #18, #35, #36, #53, #54, #71, and #72), the parity information may be combined and included in the last four dies of the entire stripe, such as the parity dies 310-c in FIG. 3B (e.g., dies #69, #70, #71 and #72). The four parity dies 310-c may store sufficient parity information to support DDDC and correction of two data dies 310-a at a given time. As such, the other dies previously used for storing parity information may become available and may be repurposed as extra capacity dies 310-b. Thus, the memory system may include four extra capacity dies 310-b in this example, four parity dies 310-c, and 64 data dies 310-a. The larger access granularity of 256B may provide for the memory system to repurpose the parity dies in such a way to support DDDC while still having four extra (e.g., unused) parity dies that can be repurposed as the extra capacity dies 310-b.

The four parity dies 310-c may support a second data correction capability, such as DDDC. For example, the four parity dies 310-c may support a DDDC functionality, in which up to two data dies of the data dies 310-a may be corrected at a given time (e.g., two dies per error correction operation) using two codewords. Each codeword for performing DDDC with the 256B access granularity may have a length of 72 bits and may include a payload with a length of 68 bits. In some examples, the die replacement scheme 300-b may be associated with two codewords of the same size. In some examples, the error correction engine may support a 16-bit data correction scheme, such as a 16 bit 2xReed Solomon (RS)2(72,68) scheme, or some other type of correction scheme, including an 8-bit scheme, or other scheme. The 16 bit 2xRS2(72,68) scheme may enable the memory system to correct up to two dies using two codewords, where each codeword may be 72 bits long and the payload of each codeword may be 68 bits long. For example, the data dies 310-a, the extra capacity dies 310-b, and the parity dies 310-c illustrated in FIG. 3B may represent an example of a data stripe for error correction (e.g., a DDDC stripe). In some examples, each data stripe may include two codewords, and each codeword may be associated with various even and odd symbol groups of the data stripe as further described herein with reference to FIG. 3A. For example, in FIG. 3B, a first codeword may include all even symbols (e.g., all second symbols in each of the dies #0 through #72), and a second codeword may include all odd symbols (e.g., all first symbols in each of the dies #0 through #72).

The techniques described herein may thereby be applied to various memory system architectures, such as DDR4 architectures having various burst lengths, symbol sizes, and stripe sizes (e.g., BL 8, BL 16, etc.). A quantity of available extra capacity dies 310-b within the system may vary based on the architecture of the system and other access parameters associated with the system, as well as a complexity or level of error correction that is supported by the system. As error correction capabilities of the system increase (e.g., to correct errors in more dies at a time), a quantity of parity dies 310-c in the system may increase, and a quantity of extra capacity dies 310-b in the system may decrease. Regardless, the memory systems described herein may be capable of supporting various storage schemes according to various memory protocols while rearranging parity information within a data stripe to provide room for extra capacity dies 310-b, which may improve overall performance and longevity of the systems.

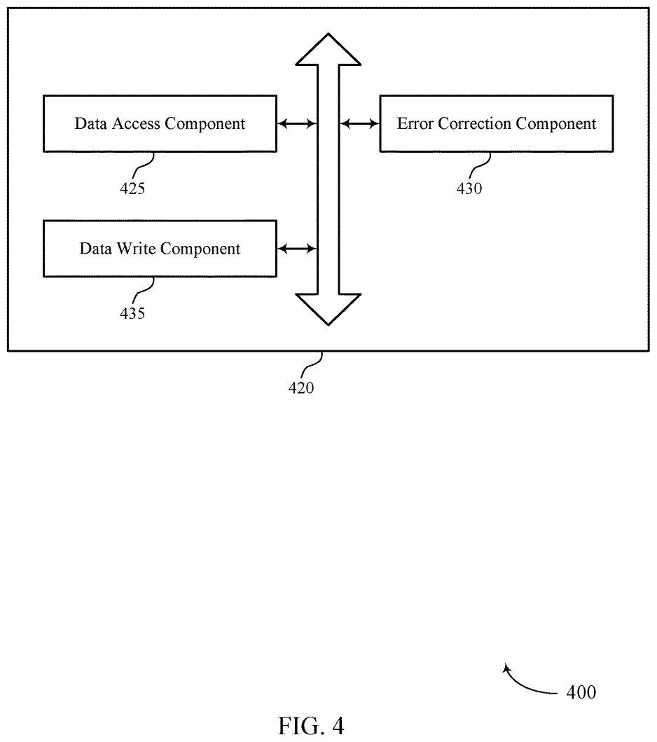

FIG. 4 shows a block diagram 400 of a memory system 420 that supports memory replacement techniques for memory subsystems in accordance with examples as disclosed herein. The memory system 420 may be an example of aspects of a memory system as described with reference to FIGS. 1 through 3. The memory system 420, or various components thereof, may be an example of means for performing (e.g., to cause the memory system 420 to perform) various aspects of memory replacement techniques for memory subsystems as described herein. For example, the memory system 420 may include a data access component 425, an error correction component 430, a data write component 435, or any combination thereof. Each of these components, or components of subcomponents thereof (e.g., one or more processors, one or more memories), may communicate, directly or indirectly, with one another (e.g., via one or more buses).

The data access component 425 may be configured as or otherwise support a means for accessing first data stored in a first die of a plurality of first dies of the memory system in accordance with an access granularity. The error correction component 430 may be configured as or otherwise support a means for correcting, in accordance with a single die data correction scheme supported by the memory system and a codeword, one or more errors in first data stored in the first die, where the memory system includes: the plurality of first dies for storing data; a plurality of second dies for storing parity information associated with the single die data correction scheme; and one or more third dies for storing corrected data from one or more first dies of the plurality of first dies in accordance with a die replacement scheme supported by the memory system, where the codeword includes the data stored within each first die of the plurality of first dies, each second die of the plurality of second dies, and the one or more third dies in accordance with the access granularity. The data write component 435 may be configured as or otherwise support a means for writing the corrected first data to a third die of the one or more third dies in accordance with the die replacement scheme and the access granularity. In some examples, the data write component 435 may be configured as or otherwise support a means for writing, in accordance with writing the corrected first data to the third die, null data to the first die to replace the first data previously stored to the first die.

In some examples, a length of the codeword includes a first quantity of bytes stored to the plurality of first dies, a second quantity of bytes stored to the plurality of second dies, and a third quantity of bytes stored to the one or more third dies.

In some examples, the codeword includes all symbols included in each first die of the plurality of first dies, each second die of the plurality of second dies, and each third die of the one or more third dies.

In some examples, the access granularity includes a 128 byte access granularity.

In some examples, a length of the codeword is 72 bytes and a length of a payload of the codeword is 68 bytes in accordance with the access granularity including the 128 byte access granularity.

In some examples, the one or more third dies include two third dies in accordance with the access granularity including the 128 byte access granularity.

In some examples, the access granularity includes a 256 byte access granularity.

In some examples, a length of the codeword is 144 bytes and a length of a payload of the codeword is 140 bytes in accordance with the access granularity including the 256 byte access granularity.

In some examples, the one or more third dies include six third dies in accordance with the access granularity including the 256 byte access granularity.

In some examples, to support correcting the one or more errors in the first die, the error correction component 430 may be configured as or otherwise support a means for correcting the one or more errors in the first die in accordance with the single die data correction scheme and the codeword, where the plurality of second dies includes a first quantity of second dies for storage of the parity information to support the single die data correction scheme.

In some examples, to support accessing the first data stored in the first die, the data access component 425 may be configured as or otherwise support a means for accessing the first die via one or more bitlines of a quantity of bitlines, where the quantity includes eight bitlines.

In some examples, the data access component 425 may be configured as or otherwise support a means for accessing first data stored in one or more first dies of a plurality of first dies of the memory system in accordance with a 256 byte access granularity. In some examples, the error correction component 430 may be configured as or otherwise support a means for correcting, in accordance with a double die data correction scheme supported by the memory system and two codewords, one or more errors in the first data, where the memory system includes: the plurality of first dies for storing data; a plurality of second dies for storing parity information associated with the double die data correction scheme; and one or more third dies for storing corrected data from one or more first dies of the plurality of first dies in accordance with a die replacement scheme supported by the memory system, where each codeword of the two codewords includes a portion of the data stored within each of the plurality of first dies, the plurality of second dies, and the one or more third dies in accordance with the 256 byte access granularity. In some examples, the data write component 435 may be configured as or otherwise support a means for writing the corrected first data to at least a third die of the one or more third dies in accordance with the die replacement scheme and the 256 byte access granularity. In some examples, the data write component 435 may be configured as or otherwise support a means for writing, in accordance with writing the corrected first data to the third die, null data to the one or more first dies to replace the first data previously stored to the one or more first dies.

In some examples, a length of each codeword is associated with a first quantity of bytes stored to the plurality of first dies, a second quantity of bytes stored to the plurality of second dies, and a third quantity of bytes stored to the one or more third dies.

In some examples, a first codeword of the two codewords includes each even symbol of a plurality of even symbols included in the plurality of first dies, the plurality of second dies, and the one or more third dies; and a second codeword of the two codewords includes each odd symbol of a plurality of odd symbols included in the plurality of first dies, the plurality of second dies, and the one or more third dies.

In some examples, a length of each codeword is 72 bytes and a length of a payload of each codeword is 68 bytes in accordance with the 256 byte access granularity.

In some examples, the one or more third dies include four third dies in accordance with the 256 byte access granularity.

In some examples, to support correcting the one or more errors in at least the first data, the error correction component 430 may be configured as or otherwise support a means for correcting the one or more errors in a first die and a second die of the plurality of first dies in accordance with the double die data correction scheme and the two codewords, where the plurality of second dies includes a second quantity of second dies for storage of the parity information to support the double die data correction scheme, and where the corrected first data is written to the third die and a fourth die of the one or more third dies in accordance with the one or more errors being in the first die and the second die.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 420 to perform one or more operations. In some examples, the described functionality of the memory system 420, or various components thereof, may be implemented at least in part by instructions (e.g., stored in memory, non-transitory computer-readable medium) executable by such at least one processor to cause the memory system 420 to perform one or more operations.

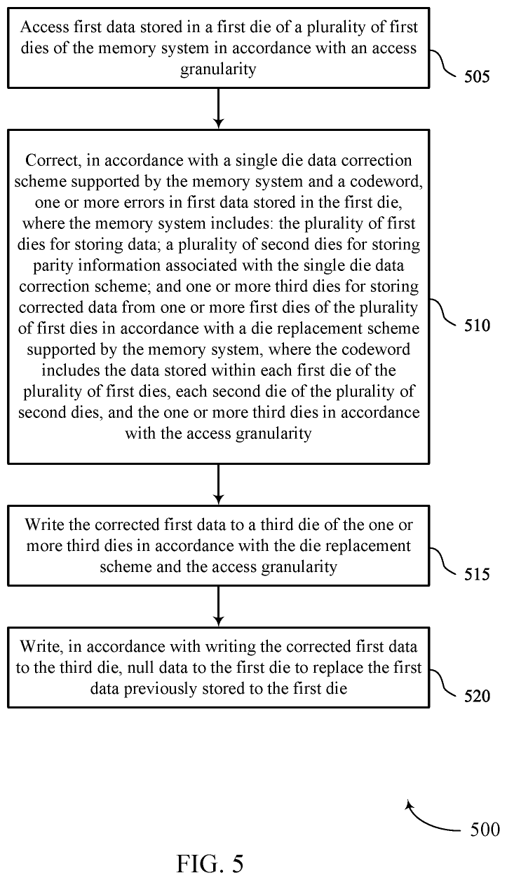

FIG. 5 shows a flowchart illustrating a method 500 that supports memory replacement techniques for memory subsystems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include accessing first data stored in a first die of a plurality of first dies of the memory system in accordance with an access granularity. In some examples, aspects of the operations of 505 may be performed by a data access component 425. For example, the memory system may access data in a data die 210-a of multiple data dies 210-a in accordance with an access granularity, as described herein with reference to FIGS. 2A and 2B.

At 510, the method may include correcting, in accordance with a single die data correction scheme supported by the memory system and a codeword, one or more errors in first data stored in the first die, where the memory system includes: the plurality of first dies for storing data (e.g., data dies 210-a); a plurality of second dies for storing parity information associated with the single die data correction scheme (e.g., parity dies 210-c); and one or more third dies for storing corrected data from one or more first dies of the plurality of first dies in accordance with a die replacement scheme supported by the memory system (e.g., extra capacity dies 210-b), where the codeword includes the data stored within each first die of the plurality of first dies, each second die of the plurality of second dies, and the one or more third dies in accordance with the access granularity. In some examples, aspects of the operations of 510 may be performed by an error correction component 430. For example, the memory system may correct one or more errors in data stored to the data die 210-a in accordance with a single die data correction scheme supported by the memory system and a codeword, as described herein with reference to FIGS. 2A and 2B.

At 515, the method may include writing the corrected first data to a third die of the one or more third dies in accordance with the die replacement scheme and the access granularity. In some examples, aspects of the operations of 515 may be performed by a data write component 435. For example, the memory system may write the corrected data to an extra capacity die 210-b of multiple extra capacity dies 210-b in accordance with the die replacement scheme and the access granularity, as described herein with reference to FIGS. 2A and 2B.

At 520, the method may include writing, in accordance with writing the corrected first data to the third die, null data to the first die to replace the first data previously stored to the first die. In some examples, aspects of the operations of 520 may be performed by a data write component 435. For example, the memory system may write null data to the data die 210-a to replace the data previously stored to the data die 210-a in accordance with writing the corrected data to the extra capacity die 210-b, as described herein with reference to FIGS. 2A and 2B.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for accessing first data stored in a first die of a plurality of first dies of the memory system in accordance with an access granularity; correcting, in accordance with a single die data correction scheme supported by the memory system and a codeword, one or more errors in first data stored in the first die, where the memory system includes: the plurality of first dies for storing data; a plurality of second dies for storing parity information associated with the single die data correction scheme; and one or more third dies for storing corrected data from one or more first dies of the plurality of first dies in accordance with a die replacement scheme supported by the memory system, where the codeword includes the data stored within each first die of the plurality of first dies, each second die of the plurality of second dies, and the one or more third dies in accordance with the access granularity; writing the corrected first data to a third die of the one or more third dies in accordance with the die replacement scheme and the access granularity; and writing, in accordance with writing the corrected first data to the third die, null data to the first die to replace the first data previously stored to the first die.
Aspect 2: The method, apparatus, or non-transitory computer-readable medium of aspect 1, where a length of the codeword includes a first quantity of bytes stored to the plurality of first dies, a second quantity of bytes stored to the plurality of second dies, and a third quantity of bytes stored to the one or more third dies.
Aspect 3: The method, apparatus, or non-transitory computer-readable medium of any of aspects 1 through 2, where the codeword includes all symbols included in each first die of the plurality of first dies, each second die of the plurality of second dies, and each third die of the one or more third dies.
Aspect 4: The method, apparatus, or non-transitory computer-readable medium of any of aspects 1 through 3, where the access granularity includes a 128 byte access granularity.
Aspect 5: The method, apparatus, or non-transitory computer-readable medium of aspect 4, where a length of the codeword is 72 bytes and a length of a payload of the codeword is 68 bytes in accordance with the access granularity including the 128 byte access granularity.
Aspect 6: The method, apparatus, or non-transitory computer-readable medium of any of aspects 4 through 5, where the one or more third dies include two third dies in accordance with the access granularity including the 128 byte access granularity.
Aspect 7: The method, apparatus, or non-transitory computer-readable medium of any of aspects 1 through 6, where the access granularity includes a 256 byte access granularity.
Aspect 8: The method, apparatus, or non-transitory computer-readable medium of aspect 7, where a length of the codeword is 144 bytes and a length of a payload of the codeword is 140 bytes in accordance with the access granularity including the 256 byte access granularity.
Aspect 9: The method, apparatus, or non-transitory computer-readable medium of any of aspects 7 through 8, where the one or more third dies include six third dies in accordance with the access granularity including the 256 byte access granularity.
Aspect 10: The method, apparatus, or non-transitory computer-readable medium of any of aspects 1 through 9, where correcting the one or more errors in the first die includes operations, features, circuitry, logic, means, or instructions, or any combination thereof for correcting the one or more errors in the first die in accordance with the single die data correction scheme and the codeword, where the plurality of second dies includes a first quantity of second dies for storage of the parity information to support the single die data correction scheme.
Aspect 11: The method, apparatus, or non-transitory computer-readable medium of any of aspects 1 through 10, where accessing the first data stored in the first die includes operations, features, circuitry, logic, means, or instructions, or any combination thereof for accessing the first die via one or more bitlines of a quantity of bitlines, where the quantity includes eight bitlines.

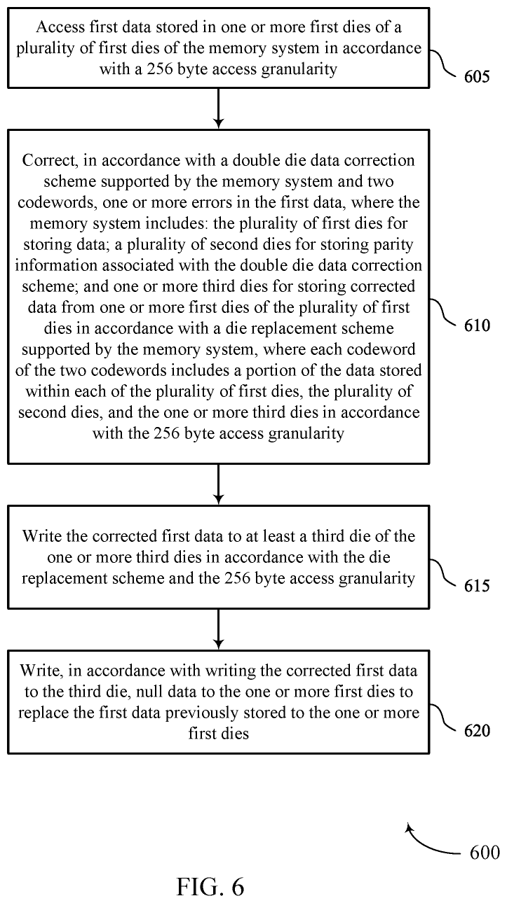

FIG. 6 shows a flowchart illustrating a method 600 that supports memory replacement techniques for memory subsystems in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include accessing first data stored in one or more first dies of a plurality of first dies of the memory system in accordance with a 256 byte access granularity. In some examples, aspects of the operations of 605 may be performed by a data access component 425. For example, the memory system may access data in a data die 310-a of multiple data dies 310-a in accordance with a 256 access granularity, as described herein with reference to FIGS. 3A and 3B.

At 610, the method may include correcting, in accordance with a double die data correction scheme supported by the memory system and two codewords, one or more errors in the first data, where the memory system includes: the plurality of first dies for storing data (e.g., data dies 310-a); a plurality of second dies for storing parity information associated with the double die data correction scheme (e.g., parity dies 310-c); and one or more third dies for storing corrected data from one or more first dies of the plurality of first dies in accordance with a die replacement scheme supported by the memory system (e.g., extra capacity dies 310-b), where each codeword of the two codewords includes a portion of the data stored within each of the plurality of first dies, the plurality of second dies, and the one or more third dies in accordance with the 256 byte access granularity. In some examples, aspects of the operations of 610 may be performed by an error correction component 430. For example, the memory system may correct one or more errors in data stored to the data die 310-a in accordance with a double die data correction scheme supported by the memory system and a codeword, as described herein with reference to FIGS. 3A and 3B.

At 615, the method may include writing the corrected first data to at least a third die of the one or more third dies in accordance with the die replacement scheme and the 256 byte access granularity. In some examples, aspects of the operations of 615 may be performed by a data write component 435. For example, the memory system may write the corrected data to an extra capacity die 310-b of multiple extra capacity dies 310-b in accordance with the die replacement scheme and the 256 byte access granularity, as described herein with reference to FIG. 3B.

At 620, the method may include writing, in accordance with writing the corrected first data to the third die, null data to the one or more first dies to replace the first data previously stored to the one or more first dies. In some examples, aspects of the operations of 620 may be performed by a data write component 435. For example, the memory system may write null data to the data die 310-a to replace the data previously stored to the data die 310-a in accordance with writing the corrected data to the extra capacity die 310-b, as described herein with reference to FIG. 3B.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 12: A method, apparatus, or non-transitory computer-readable medium including operations, features, circuitry, logic, means, or instructions, or any combination thereof for accessing first data stored in one or more first dies of a plurality of first dies of the memory system in accordance with a 256 byte access granularity; correcting, in accordance with a double die data correction scheme supported by the memory system and two codewords, one or more errors in the first data, where the memory system includes: the plurality of first dies for storing data; a plurality of second dies for storing parity information associated with the double die data correction scheme; and one or more third dies for storing corrected data from one or more first dies of the plurality of first dies in accordance with a die replacement scheme supported by the memory system, where each codeword of the two codewords includes a portion of the data stored within each of the plurality of first dies, the plurality of second dies, and the one or more third dies in accordance with the 256 byte access granularity; writing the corrected first data to at least a third die of the one or more third dies in accordance with the die replacement scheme and the 256 byte access granularity; and writing, in accordance with writing the corrected first data to the third die, null data to the one or more first dies to replace the first data previously stored to the one or more first dies.
Aspect 13: The method, apparatus, or non-transitory computer-readable medium of aspect 12, where a length of each codeword is associated with a first quantity of bytes stored to the plurality of first dies, a second quantity of bytes stored to the plurality of second dies, and a third quantity of bytes stored to the one or more third dies.
Aspect 14: The method, apparatus, or non-transitory computer-readable medium of any of aspects 12 through 13, where a first codeword of the two codewords includes each even symbol of a plurality of even symbols included in the plurality of first dies, the plurality of second dies, and the one or more third dies; and a second codeword of the two codewords includes each odd symbol of a plurality of odd symbols included in the plurality of first dies, the plurality of second dies, and the one or more third dies.
Aspect 15: The method, apparatus, or non-transitory computer-readable medium of any of aspects 12 through 14, where a length of each codeword is 72 bytes and a length of a payload of each codeword is 68 bytes in accordance with the 256 byte access granularity.
Aspect 16: The method, apparatus, or non-transitory computer-readable medium of any of aspects 12 through 15, where the one or more third dies include four third dies in accordance with the 256 byte access granularity.
Aspect 17: The method, apparatus, or non-transitory computer-readable medium of any of aspects 12 through 16, where correcting the one or more errors in at least the first data includes operations, features, circuitry, logic, means, or instructions, or any combination thereof for correcting the one or more errors in a first die and a second die of the plurality of first dies in accordance with the double die data correction scheme and the two codewords, where the plurality of second dies includes a second quantity of second dies for storage of the parity information to support the double die data correction scheme, and where the corrected first data is written to the third die and a fourth die of the one or more third dies in accordance with the one or more errors being in the first die and the second die.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
access first data stored in a first die of a plurality of first dies of the memory system in accordance with an access granularity;
correct, in accordance with a single die data correction scheme supported by the memory system and a codeword, one or more errors in the first data stored in the first die, wherein the memory system comprises:
the plurality of first dies for storing data; a plurality of second dies for storing parity information associated with the single die data correction scheme; and
one or more third dies for storing corrected data from one or more first dies of the plurality of first dies in accordance with a die replacement scheme supported by the memory system, wherein the codeword comprises the data stored within each first die of the plurality of first dies, each second die of the plurality of second dies, and the one or more third dies in accordance with the access granularity;
write the corrected first data to a third die of the one or more third dies in accordance with the die replacement scheme and the access granularity; and
write, in accordance with writing the corrected first data to the third die, null data to the first die to replace the first data previously stored to the first die.

2. The memory system of claim 1, wherein a length of the codeword comprises a first quantity of bytes stored to the plurality of first dies, a second quantity of bytes stored to the plurality of second dies, and a third quantity of bytes stored to the one or more third dies.

3. The memory system of claim 1, wherein the codeword comprises all symbols included in each first die of the plurality of first dies, each second die of the plurality of second dies, and each third die of the one or more third dies.

4. The memory system of claim 1, wherein the access granularity comprises a 128 byte access granularity.

5. The memory system of claim 4, wherein a length of the codeword is 72 bytes and a length of a payload of the codeword is 68 bytes in accordance with the access granularity comprising the 128 byte access granularity.

6. The memory system of claim 4, wherein the one or more third dies comprise two third dies in accordance with the access granularity comprising the 128 byte access granularity.

7. The memory system of claim 1, wherein the access granularity comprises a 256 byte access granularity.

8. The memory system of claim 7, wherein a length of the codeword is 144 bytes and a length of a payload of the codeword is 140 bytes in accordance with the access granularity comprising the 256 byte access granularity.

9. The memory system of claim 7, wherein the one or more third dies comprise six third dies in accordance with the access granularity comprising the 256 byte access granularity.

10. The memory system of claim 1, wherein correcting the one or more errors in the first die comprises the processing circuitry configured to cause the memory system to:
correct the one or more errors in the first die in accordance with the single die data correction scheme and the codeword, wherein the plurality of second dies comprises a first quantity of second dies for storage of the parity information to support the single die data correction scheme.

11. The memory system of claim 1, wherein accessing the first data stored in the first die comprises the processing circuitry configured to cause the memory system to:
access the first die via one or more bitlines of a quantity of bitlines, wherein the quantity comprises eight bitlines.

12. A memory system, comprising:
one or more memory devices; and
processing circuitry coupled with the one or more memory devices and configured to cause the memory system to:
access first data stored in one or more first dies of a plurality of first dies of the memory system in accordance with a 256 byte access granularity;
correct, in accordance with a double die data correction scheme supported by the memory system and two codewords, one or more errors in the first data, wherein the memory system comprises:
the plurality of first dies for storing data; a plurality of second dies for storing parity information associated with the double die data correction scheme; and
one or more third dies for storing corrected data from the one or more first dies of the plurality of first dies in accordance with a die replacement scheme supported by the memory system, wherein each codeword of the two codewords comprises a portion of the data stored within each of the plurality of first dies, the plurality of second dies, and the one or more third dies in accordance with the 256 byte access granularity;
write the corrected first data to at least a third die of the one or more third dies in accordance with the die replacement scheme and the 256 byte access granularity; and
write, in accordance with writing the corrected first data to the third die, null data to the one or more first dies to replace the first data previously stored to the one or more first dies.

13. The memory system of claim 12, wherein a length of each codeword is associated with a first quantity of bytes stored to the plurality of first dies, a second quantity of bytes stored to the plurality of second dies, and a third quantity of bytes stored to the one or more third dies.

14. The memory system of claim 12, wherein a first codeword of the two codewords comprises each even symbol of a plurality of even symbols included in the plurality of first dies, the plurality of second dies, and the one or more third dies; and a second codeword of the two codewords comprises each odd symbol of a plurality of odd symbols included in the plurality of first dies, the plurality of second dies, and the one or more third dies.

15. The memory system of claim 12, wherein a length of each codeword is 72 bytes and a length of a payload of each codeword is 68 bytes in accordance with the 256 byte access granularity.

16. The memory system of claim 12, wherein the one or more third dies comprise four third dies in accordance with the 256 byte access granularity.

17. The memory system of claim 12, wherein correcting the one or more errors in at least the first data comprises the processing circuitry configured to cause the memory system to:
correct the one or more errors in a first die and a second die of the plurality of first dies in accordance with the double die data correction scheme and the two codewords, wherein the plurality of second dies comprises a second quantity of second dies for storage of the parity information to support the double die data correction scheme, and wherein the corrected first data is written to the third die and a fourth die of the one or more third dies in accordance with the one or more errors being in the first die and the second die.

18. A method by a memory system, comprising:
accessing first data stored in a first die of a plurality of first dies of the memory system in accordance with an access granularity;
correcting, in accordance with a single die data correction scheme supported by the memory system and a codeword, one or more errors in the first data stored in the first die, wherein the memory system comprises:
the plurality of first dies for storing data; a plurality of second dies for storing parity information associated with the single die data correction scheme; and
one or more third dies for storing corrected data from one or more first dies of the plurality of first dies in accordance with a die replacement scheme supported by the memory system, wherein the codeword comprises the data stored within each first die of the plurality of first dies, each second die of the plurality of second dies, and the one or more third dies in accordance with the access granularity;
writing the corrected first data to a third die of the one or more third dies in accordance with the die replacement scheme and the access granularity; and
writing, in accordance with writing the corrected first data to the third die, null data to the first die to replace the first data previously stored to the first die.

19. The method of claim 18, wherein a length of the codeword comprises a first quantity of bytes stored to the plurality of first dies, a second quantity of bytes stored to the plurality of second dies, and a third quantity of bytes stored to the one or more third dies.

20. The method of claim 18, wherein the codeword comprises all symbols included in each first die of the plurality of first dies, each second die of the plurality of second dies, and each third die of the one or more third dies.

21. The method of claim 18, wherein the access granularity comprises a 128 byte access granularity.

22. The method of claim 21, wherein a length of the codeword is 72 bytes and a length of a payload of the codeword is 68 bytes in accordance with the access granularity comprising the 128 byte access granularity.

23. The method of claim 21, wherein the one or more third dies comprise two third dies in accordance with the access granularity comprising the 128 byte access granularity.

24. The method of claim 18, wherein the access granularity comprises a 256 byte access granularity.

25. The method of claim 24, wherein a length of the codeword is 144 bytes and a length of a payload of the codeword is 140 bytes in accordance with the access granularity comprising the 256 byte access granularity.

26. The method of claim 24, wherein the one or more third dies comprise six third dies in accordance with the access granularity comprising the 256 byte access granularity.

27. The method of claim 18, wherein correcting the one or more errors in the first die comprises:
correcting the one or more errors in the first die in accordance with the single die data correction scheme and the codeword, wherein the plurality of second dies comprises a first quantity of second dies for storage of the parity information to support the single die data correction scheme.

28. The method of claim 18, wherein accessing the first data stored in the first die comprises:
accessing the first die via one or more bitlines of a quantity of bitlines, wherein the quantity comprises eight bitlines.

29. A method by a memory system, comprising:
accessing first data stored in one or more first dies of a plurality of first dies of the memory system in accordance with a 256 byte access granularity;
correcting, in accordance with a double die data correction scheme supported by the memory system and two codewords, one or more errors in the first data, wherein the memory system comprises:
the plurality of first dies for storing data; a plurality of second dies for storing parity information associated with the double die data correction scheme; and
one or more third dies for storing corrected data from the one or more first dies of the plurality of first dies in accordance with a die replacement scheme supported by the memory system, wherein each codeword of the two codewords comprises a portion of the data stored within each of the plurality of first dies, the plurality of second dies, and the one or more third dies in accordance with the 256 byte access granularity;
writing the corrected first data to at least a third die of the one or more third dies in accordance with the die replacement scheme and the 256 byte access granularity; and
writing, in accordance with writing the corrected first data to the third die, null data to the one or more first dies to replace the first data previously stored to the one or more first dies.

30. A non-transitory computer-readable medium storing code, the code comprising instructions executable by one or more processors to:
access first data stored in a first die of a plurality of first dies of a memory system in accordance with an access granularity;
correct, in accordance with a single die data correction scheme supported by the memory system and a codeword, one or more errors in the first data stored in the first die, wherein the memory system comprises:
the plurality of first dies for storing data; a plurality of second dies for storing parity information associated with the single die data correction scheme; and
one or more third dies for storing corrected data from one or more first dies of the plurality of first dies in accordance with a die replacement scheme supported by the memory system, wherein the codeword comprises the data stored within each first die of the plurality of first dies, each second die of the plurality of second dies, and the one or more third dies in accordance with the access granularity;
write the corrected first data to a third die of the one or more third dies in accordance with the die replacement scheme and the access granularity; and
write, in accordance with writing the corrected first data to the third die, null data to the first die to replace the first data previously stored to the first die.
